(19) United States
(12) Patent Application Publication
(10) Pub. No.: US 2025/0301935 A1
(43) Pub. Date: Oct. 2, 2025

(54) AGRICULTURAL IMPLEMENT WITH IMPROVED GROUND-ENGAGING TOOL DEPTH CONTROL

(71) Applicant: CNH Industrial America LLC, New Holland, PA (US)

(72) Inventors: Heath Toennies, Eureka, IL (US); Jason E. Andrews, Eureka, IL (US); Riley Jackson, Washington, IL (US); Jason Feller, Long Grove, IA (US)

(21) Appl. No.: 18/620,088

(22) Filed: Mar. 28, 2024

(51) Int. Cl. A01B 63/28; A01B 63/00

(52) U.S. Cl. CPC A01B 63/28; A01B 63/008

(57) ABSTRACT

A system for controlling the operation of an agricultural implement includes a ground-engaging tool and a fluid-driven actuator for adjusting the soil penetration depth of the tool. Moreover, the system includes a linkage assembly coupled to the frame of the implement and configured to move when the soil penetration depth of the tool is adjusted. Furthermore, the system includes a fluid circuit for conveying a flow of pressurized fluid between the actuator and a fluid source. The circuit includes a blocking valve that blocks the flow of the fluid when activated to prevent the actuator from adjusting the soil penetration depth. Additionally, the system includes a proximity sensor configured to detect the presence of the linkage assembly when the linkage assembly moves into the detection range of the sensor. Moreover, the system includes a relay configured to activate the valve when the sensor detects the presence of the linkage assembly.

### FIELD OF THE INVENTION

The present disclosure generally relates to agricultural implements and, more particularly, to agricultural implements with improved ground-engaging tool depth control.

### BACKGROUND OF THE INVENTION

It is well known that, to attain the best agricultural performance from a field, a farmer must cultivate the soil, typically through a tillage operation. Modern farmers perform tillage operations by pulling a tillage implement behind an agricultural work vehicle, such as a tractor. In certain configurations, tillage implements include one or more ground-engaging tools, such as shanks and/or spaced apart disks, supported on its frame. Each ground-engaging tool of the tillage implement loosens and/or otherwise agitates the soil to prepare the field for subsequent planting operations.

During tillage operations, the soil penetration depth of the ground-engaging tools is typically adjusted using one or more fluid circuits to convey pressurized fluid to adjust the height of the frame supporting the ground-engaging tools. The fluid circuit(s) is commonly connected to one or more valves, which are currently prone to leaks and sticking/jamming. Such leaks and other current valve issues may also cause linkages connected to the frame of the implement to bend or deform under compression load.

Accordingly, an agricultural implement with improved ground-engaging tool depth control would be welcomed in the technology.

### SUMMARY OF THE INVENTION

Aspects and advantages of the technology will be set forth in part in the following description, or may be obvious from the description, or may be learned through practice of the technology.

In one aspect, the present subject matter is directed to an agricultural implement. The agricultural implement includes a frame and a ground-engaging tool supported by the frame for penetrating soil of a field as the agricultural implement traverses the field. Additionally, the agricultural implement includes a fluid-driven actuator for adjusting a soil penetration depth of the ground-engaging tool. Moreover, the agricultural implement includes a linkage assembly coupled to the frame and configured to move with the frame when the soil penetration depth of the ground-engaging tool is adjusted. Furthermore, the agricultural implement includes a fluid circuit for conveying a flow of pressurized fluid between the fluid-driven actuator and a fluid source. The fluid circuit includes a blocking valve configured to be electrically energized and de-energized such that, when energized, the blocking valve permits the flow of pressurized fluid between the fluid-driven actuator and the fluid source to allow the fluid-driven actuator to adjust the soil penetration depth of the ground engaging tool and, when de-energized, the blocking valve blocks the flow of pressurized fluid between the fluid-driven actuator and the fluid source to prevent the fluid-driven actuator from adjusting the soil penetration depth of the ground-engaging tool.

In another aspect, the present subject matter is directed to a system for controlling the operation of an agricultural implement. The system includes a ground-engaging tool for penetrating soil of a field as the agricultural implement traverses the field. Additionally, the system includes a fluid-driven actuator for adjusting a soil penetration depth of the ground-engaging tool. Moreover, the system includes a linkage assembly coupled to a frame of the agricultural implement and configured to move with the frame when the soil penetration depth of the ground-engaging tool is adjusted. Furthermore, the system includes a fluid circuit for conveying a flow of pressurized fluid between the fluid-driven actuator and a fluid source, the fluid circuit comprising a blocking valve that, when activated, blocks the flow of pressurized fluid between the fluid-driven actuator and the fluid source to prevent the fluid-driven actuator from adjusting the soil penetration depth of the ground-engaging tool.

In a further aspect, the present subject matter is directed to a method for controlling the operation of an agricultural implement. The method includes controlling, with a computing system, an operation of a fluid-driven actuator to adjust a soil penetration depth of a ground-engaging tool of an agricultural implement to move a linkage assembly. Additionally, the method includes detecting, with the computing system, a presence of the linkage assembly when the linkage assembly moves into a detection range of a proximity sensor. Furthermore, upon detection of the presence of the linkage assembly, the method includes activating, with the computing system, a blocking valve to block a flow of pressurized fluid within a fluid circuit between the fluid-driven actuator and a fluid source.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a perspective view of one embodiment of an agricultural implement coupled to a work vehicle in accordance with aspects of the present subject matter;

FIG. 2 illustrates a perspective view of the agricultural implement shown in FIG. 1;

FIG. 3A illustrates a partial perspective view of the agricultural implement shown in FIG. 1, particularly illustrating a linkage assembly of the agricultural implement;

FIG. 3B illustrates a partial perspective view of the linkage assembly shown in FIG. 3A in a retracted position;

FIG. 3C illustrates a partial perspective view of the linkage assembly shown in FIG. 3A in an extended position;

FIG. 4 illustrates a schematic view of one embodiment of a system for controlling the operation of an agricultural implement in accordance with aspects of the present subject matter; and

FIG. 5 illustrates a flow diagram of one embodiment of a method for controlling the operation of an agricultural implement in accordance with aspects of the present subject matter.

Repeat use of reference characters in the present specification and drawings is intended to represent the same or analogous features or elements of the present technology.

### DETAILED DESCRIPTION OF THE DRAWINGS

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to an agricultural implement, such as a tillage implement. As will be described below, the agricultural implement generally includes a frame and one or more ground-engaging tools, such as a harrow disk blade(s), supported by the frame for penetrating the soil of a field as the agricultural implement traverses the field. Additionally, the agricultural implement includes one or more fluid-driven actuators, such as a hydraulically driven actuator(s), for adjusting the soil penetration depth of the ground-engaging tool(s). As such, the agricultural implement includes a fluid circuit for conveying a flow of pressurized fluid, such as hydraulic fluid, between the fluid-driven actuator(s) and a fluid source, such as a tank. The fluid circuit includes a blocking valve that, when de-energized/activated, blocks the flow of pressurized fluid between the fluid-driven actuator(s) and the fluid source to prevent the fluid-driven actuator(s) from adjusting the soil penetration depth of the ground-engaging tool(s). Furthermore, the agricultural implement includes one or more linkage assemblies coupled to the frame. The linkage assembly(ies) is configured to move with the frame when the soil penetration depth of the ground-engaging tool(s) is adjusted.

In several embodiments, a relay of the disclosed system is configured to activate the blocking valve to prevent the fluid-driven actuator(s) from adjusting the soil penetration depth of the ground-engaging tool(s). More specifically, a proximity sensor of the agricultural implement is configured to detect the presence of the linkage assembly(ies) when the linkage assembly(ies) moves into a detection range of the proximity sensor. Thereafter, the relay is configured to activate the blocking valve when the proximity sensor detects the presence of the linkage assembly(ies). In some embodiments, the linkage assembly(ies) is configured to move toward the detection range of the proximity sensor with decreases in the soil penetration depth of the ground-engaging tool(s). Furthermore, in some embodiments, the linkage assembly(ies) is configured to move away from the detection range of the proximity sensor with increase in the soil penetration depth of the ground-engaging tool(s).

Using the detected presence of the linkage assembly(ies) to prevent adjustment of the soil penetration depth of the ground-engaging tools of an agricultural implement improves the operation of the agricultural implement. More specifically, when one or more valves connected to the fluid circuit(s) of the agricultural implement are leaking and/or jammed, the linkage assembly(ies), which are associated with soil penetration depth adjustment of the ground-engaging tools, may become compressed. Such compression of the linkage assembly(ies) may lead to bending/deformation or other damage to the linkage assembly(ies), which may be expensive and/or time consuming to repair. As described above, the disclosed agricultural implement includes a proximity sensor to detect the presence of the linkage assembly(ies) and a relay to de-energize/activate a blocking valve to prevent the soil penetration depth of the ground-engaging tools from being adjusted when the presence of the linkage assembly(ies) is detected and, thus, reduce and/or prevent such damage to the linkage assembly(ies).

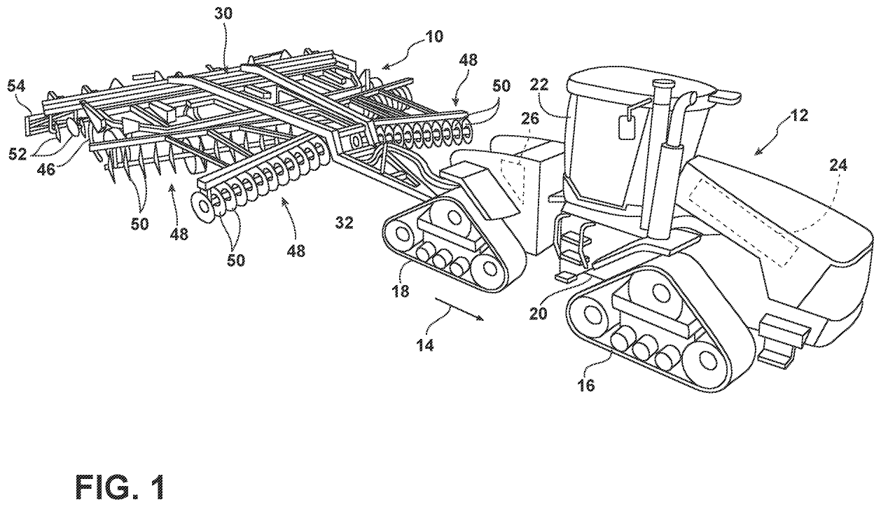

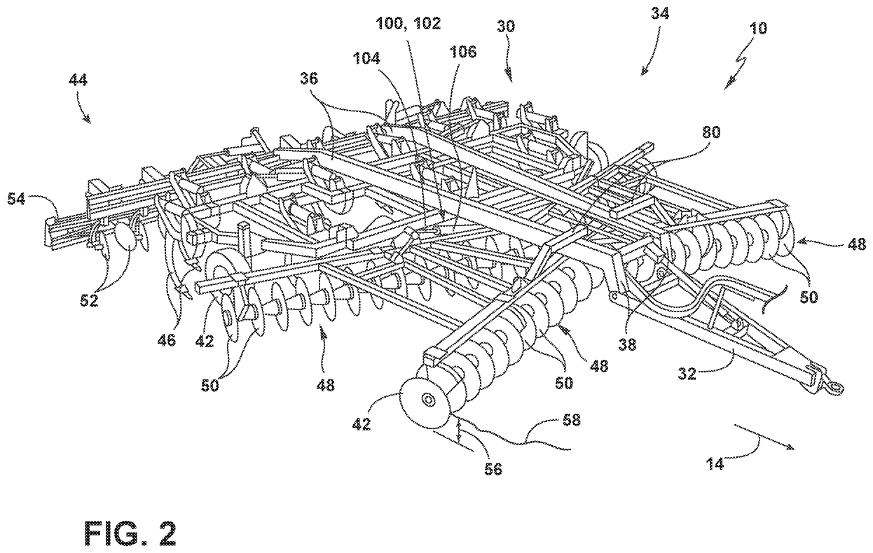

Referring now to the drawings, FIGS. 1 and 2 illustrate differing perspective views of one embodiment of an agricultural implement, configured as a tillage implement 10, in accordance with aspects of the present subject matter. Specifically, FIG. 1 illustrates a perspective view of the tillage implement 10 coupled to a work vehicle 12. Additionally, FIG. 2 illustrates a perspective view of the implement 10, particularly illustrating various components of the implement 10.

In general, the implement 10 may be configured to be towed across a field in a direction of travel (e.g., as indicated by arrow 14 in FIG. 1) by the work vehicle 12. As shown, the implement 10 is configured as a disk ripper, and the work vehicle 12 is configured as an agricultural tractor. However, in other embodiments, the implement 10 may be configured as any other suitable type of agricultural implement. Similarly, the work vehicle 12 may be configured as any other suitable type of vehicle.

As shown in FIG. 1, the work vehicle 12 may include a pair of front track assemblies 16, a pair or rear track assemblies 18, and a frame or chassis 20 coupled to and supported by the track assemblies 16, 18. An operator's cab 22 may be supported by a portion of the chassis 20 and may house various input devices for permitting an operator to control the operation of one or more components of the work vehicle 12 and/or one or more components of the implement 10. Additionally, the work vehicle 12 may include an engine 24 and a transmission 26 mounted on the chassis 20. The transmission 26 may be operably coupled to the engine 24 and may provide variably adjusted gear ratios for transferring engine power to the track assemblies 16, 18 via a drive axle assembly (not shown) (or via axles if multiple drive axles are employed).

As shown in FIGS. 1 and 2, the implement 10 may generally include a main implement frame 30 configured to be towed by the work vehicle 12 via a pull hitch or tow bar 32 in the travel direction 14. In general, as will be described below, the main implement frame 30 may support a plurality of ground-engaging tools, such as a plurality of shanks, disk blades, leveling blades, basket assemblies, tines, spikes, and/or the like. In several embodiments, the various ground-engaging tools may be configured to perform an agricultural operation, such as a tillage operation or any other suitable ground-engaging operation, across the field along which the implement 10 is being towed.

As shown in FIG. 2, the main implement frame 30 may include aft extending implement frame members 36 coupled to the tow bar 32. In addition, reinforcing gusset plates 38 may be used to strengthen the connection between the tow bar 32 and the implement frame members 36. In several embodiments, the main implement frame 30 may generally support one or more tool frames for supporting the plurality of ground-engaging tools. For example, the main implement frame 30 may be coupled to a central frame 40, a forward frame 42 positioned forward of the central frame 40 relative to the travel direction 14 of the vehicle/implement 12/10, and/or an aft frame 44 positioned aft of the central frame 40 relative to the travel direction 14 of the vehicle/implement 12/10. As shown, in one embodiment, the central frame 40 may correspond to a shank frame configured to support a plurality of ground-engaging shanks 46. In such an embodiment, the shanks 46 are configured to till or otherwise engage the soil as the implement 10 is towed across the field. However, in other embodiments, the central frame 40 may be configured to support any other suitable ground-engaging tools.

Additionally, as shown in FIG. 2, in one embodiment, the forward frame 42 may correspond to a disk frame configured to support various gangs or sets 48 of harrow disk blades 50. Specifically, the disk blades 50 are spaced apart from each other along the length of the disk gang 48 and configured to rotate relative to the soil within the field as the agricultural implement 10 travels across the field in the travel direction 14. Furthermore, each disk blade 50 may include both a concave side (not shown) and a convex side (not shown). In addition, the various gangs 48 of disk blades 50 may be oriented at an angle relative to the travel direction 14 of the vehicle/implement 12/10 to promote more effective tilling of the soil. However, in other embodiments, the forward frame 42 may be configured to support any other suitable ground-engaging tools.

Moreover, like the central and forward frames 40, 42, the aft frame 44 may also be configured to support a plurality of ground-engaging tools. For instance, in the illustrated embodiment, the aft frame 44 is configured to support a plurality of leveling blades 52 and rolling (or crumbler) basket assemblies 54. However, in other embodiments, any other suitable ground-engaging tools may be coupled to and supported by the aft frame 44, such as a plurality of closing disk blades.

Furthermore, the central, forward, and aft frames 40, 42, 44 may each be pivotably coupled to the main implement frame 30 for allowing adjustment of a soil penetration depth (as indicated by arrow 56) of the ground-engaging tools within the field 58, such as the disk blades 50. In this respect, as will be described below, one or more linkage assemblies 80 may be coupled between the main implement frame 30 and the central, forward, and aft frames 40, 42, 44 and configured to move with the respective frame 40, 42, 44 when the soil penetration depth 56 of the ground-engaging tools are adjusted. As such, the linkage assembly(ies) 80 each facilitate pivoting of the central, forward, and aft frames 40, 42, 44 relative to the main implement frame 30 and toward and/or away from the field surface.

Additionally, in several embodiments, the implement 10 may include one or more fluid-driven actuators 100 (one is shown). In general, each fluid-driven actuator 100 is configured to pivot the position of one of the central frame 40, the forward frame 42, and/or the aft frame 44 relative to the main implement frame 30 to adjust the soil penetration depth 56 of the ground-engaging tools. As such, the fluid-driven actuator(s) 102 may raise the frame 40, 42, 44 to decrease the soil penetration depth 56 of the ground-engaging tools and/or lower the frame 40, 42, 44 to increase the soil penetration depth 56 of the ground-engaging tools.

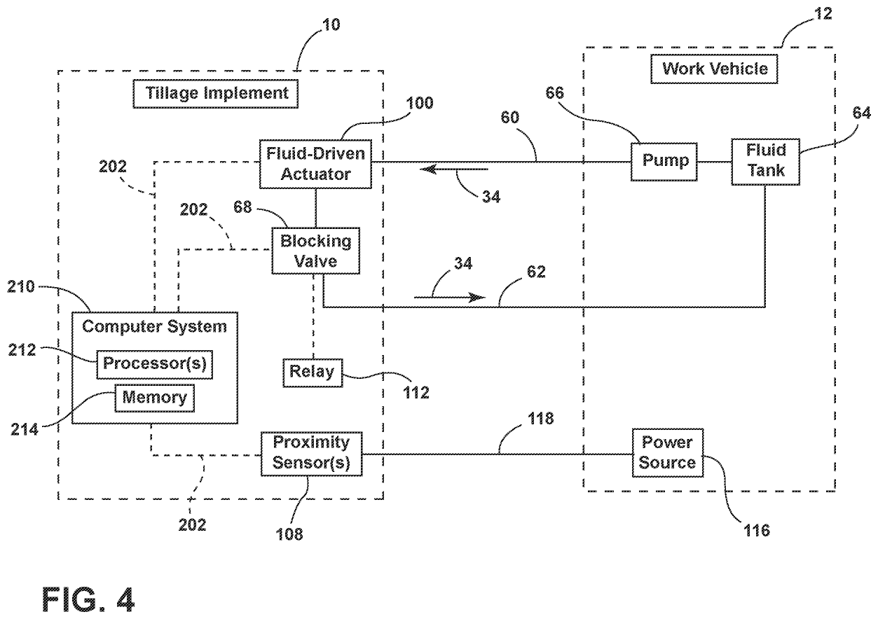

As shown in FIG. 2, the fluid-driven actuator(s) 100 is configured as a hydraulic cylinder(s) 102. A first end of each hydraulic cylinder 102 (e.g., a rod 104 of the hydraulic cylinder 102) is coupled to the forward frame 42, while a second end of each hydraulic cylinder 102 (e.g., the cylinder 106 of the hydraulic cylinder 102) is coupled to the main implement frame 30. However, it should be appreciated that the first end of each hydraulic cylinder 102 may be coupled to the central frame 40 or the aft frame 44. The rod 104 of each hydraulic cylinder 102 may be configured to extend and/or retract relative to the corresponding cylinder 106 to move the frame 40, 42, 44 relative to the main implement frame 30 to adjust the soil penetration depth 56 of the corresponding ground-engaging tools (e.g., disk blades 50). In this respect, when the rod 104 is retracted, the frame 40, 42, 44 is lowered and the soil penetration depth 56 of the ground-engaging tools is increased. Alternatively, when the rod 104 is extended, the frame 40, 42, 44 is raised and the soil penetration depth 56 of the ground-engaging tools is decreased. While each fluid-driven actuator 100 shown in FIG. 2 is configured as the hydraulic cylinder 102, it should be appreciated that each fluid-driven actuator 100 may correspond to any other suitable type of fluid-driven actuator, such as a pneumatically driven actuator. Furthermore, as will be described below, each fluid-driven actuator 100 may be fluidly coupled to a fluid circuit 60 (FIG. 4) for conveying a flow of pressurized fluid to and from the fluid-driven actuator 100 to adjust the soil penetration depth 56 of the ground-engaging tools.

The configuration of the tillage implement 10 and the work vehicle 12 described above and shown in FIGS. 1 and 2 is provided only to place the present subject matter in an exemplary field of use. Thus, the present subject matter may be readily adaptable to any manner of implement and/or vehicle configuration.

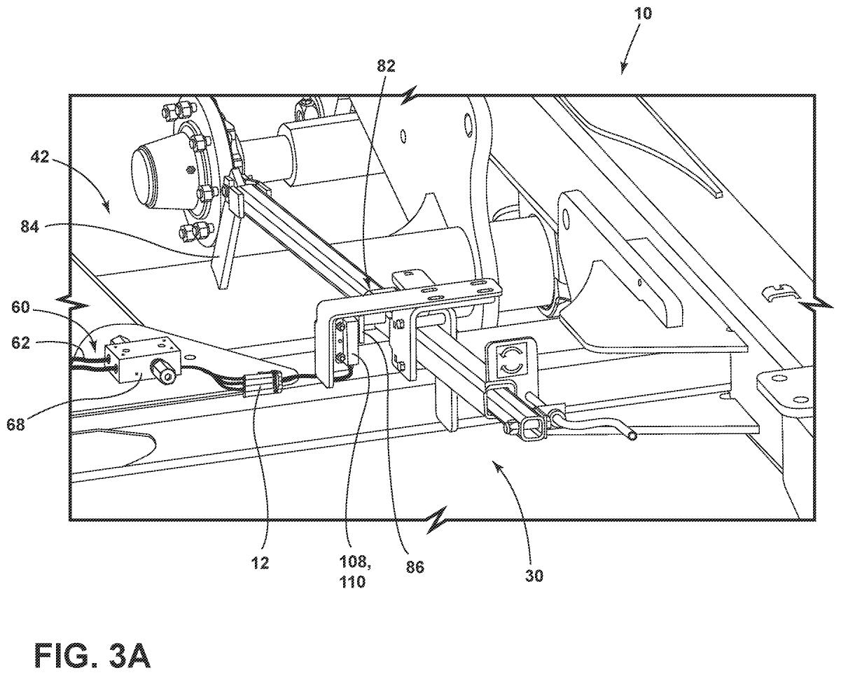

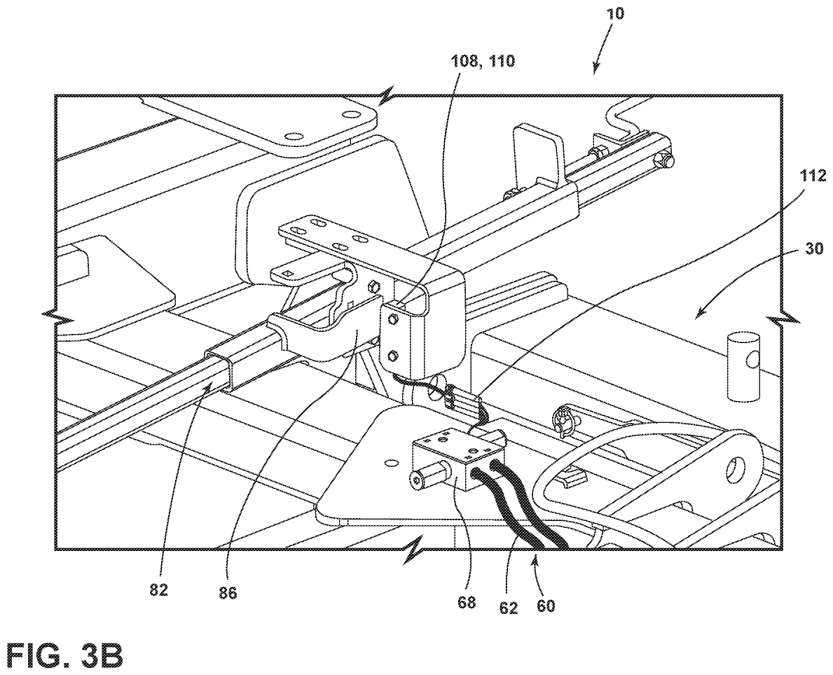

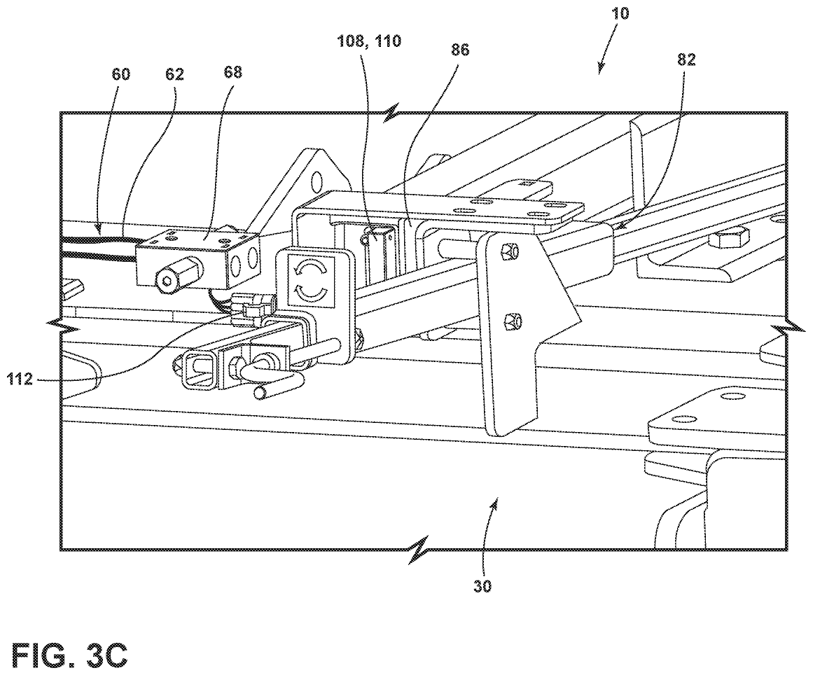

Referring now to FIGS. 3A through 3C, various views of portions of the implement 10 shown in FIGS. 1 and 2 are illustrated. Particularly, FIG. 3A illustrates a partial perspective view of the linkage assembly 80. Additionally, FIG. 3B illustrates a partial perspective view of the linkage assembly 80 in a retracted position, while FIG. 3C illustrates a partial perspective view of the linkage assembly 80 in an extended position.

The linkage assembly 80 includes a translational arm 82 coupled to the main implement frame 30 and a rotating arm 84 coupled to one of the forward, central, or aft frames 40, 42, 44. As the frame 40, 42, 44 is lowered toward the field and, thus, the soil penetration depth 56 of the ground-engaging tools is increased, the frame 40, 42, 44 rotates the rotating arm 84 in a first direction. The rotating arm, in turn, pulls the translational arm 82 toward an extended position (FIG. 3C). Likewise, as the frame 40, 42, 44 is raised away from the field and, thus, the soil penetration depth 56 of the ground-engaging tools is decreased, the frame 40, 42, 44 rotates the rotating arm in a second direction different from the first direction. The rotating arm, in turn, pushes the translational arm 82 toward a retracted position (FIG. 3B). Moreover, the translational arm 82 of the linkage assembly 80 includes an activation plate 86 protruding therefrom.

Furthermore, one or more proximity sensors 108 may be positioned on the main implement frame 30 of the implement 10. In general, the proximity sensor(s) 108 is configured to detect a presence of the linkage assembly 80, such as the activation plate 86 of the linkage assembly 80, when the linkage assembly 80 moves into a detection range of the proximity sensor(s) 108. Such detection of the linkage assembly 80 results from movement of the linkage assembly 80 when the soil penetration depth of the ground-engaging tools (e.g., harrow disks 50) is adjusted. For example, as the translational arm 82 of the linkage assembly 80 moves toward the retracted position, such as when the soil penetration depth 56 of the ground-engaging tools is decreased, the activation plate 86 moves toward the detection range of the proximity sensor 108. Likewise, as the translational arm 82 of the linkage assembly 80 moves toward the extended position, such as when the soil penetration depth 56 of the ground-engaging tools is increased, the activation plate 86 moves away from the detection range of the proximity sensor 108. As will be described below, the detection of the linkage assembly 80 by the proximity sensor 108 is, in turn, subsequently used to de-energize or activate a blocking valve, which prevents the soil penetration depth 56 of the harrow disks 50 and/or other ground-engaging tools from being adjusted.

In general, the proximity sensor(s) 108 may correspond to any suitable proximity sensing device(s) configured to detect the presence of the linkage assembly(ies) 80. For example, the proximity sensor(s) 108 may correspond to a magnetic sensor(s) 110 that detects a presence of objects attracted by an electromagnet, such as a metal object. As such, the magnetic sensor(s) 110 may be configured to detect the presence of the activation plate 86 when the activation plate 86 moves into the detection range of the magnetic sensor(s) 110. However, it should be appreciated that the proximity sensor(s) 108 may correspond to any other suitable proximity sensing device(s) such as a contact sensor(s) and/or the like.

Furthermore, any number of proximity sensors 108 may be positioned on the main implement frame 30 of the implement 10 and configured to detect the presence of the linkage assembly(ies) 80. For example, in the embodiment shown in FIGS. 3A through 3C, one proximity sensor 108 is positioned on the main implement frame 30 for detecting the presence of one linkage assembly 80.

Referring now to FIG. 4, a schematic view of one embodiment of a system 200 for controlling the operation of an agricultural implement is illustrated in accordance with aspects of the present subject matter. In general, the system 200 will be described herein with reference to the implement 10 and the work vehicle 12 described above with reference to FIGS. 1-3C. However, the disclosed system 200 may generally be utilized with agricultural implements having any other suitable implement configuration and/or with work vehicles having any other suitable vehicle configuration.

As shown in FIG. 4, the system 200 generally includes one or more components of the implement 10 and/or the work vehicle 12. For example, in the illustrated embodiment, the system 200 includes the fluid-driven actuator(s) 100 and the proximity sensor(s) 108. The proximity sensor(s) 108 is electrically coupled to a power source 116, such as a 12 volt battery, via an electrical connection 118, such as an electrical conduit, for powering the proximity sensor(s) 108. The power source 116 may be positioned on the work vehicle 12.

Furthermore, as shown in FIG. 4, the system 200 includes the fluid circuit 60, configured as a hydraulic circuit 70, which is fluidly coupled between a fluid tank 64 and the fluid-driven actuator 100 for conveying a pressurized flow of fluid (e.g., hydraulic fluid) between the fluid tank 64 and the fluid-driven actuator 100 to operate the fluid-driven actuator 100. The fluid tank 64 may be positioned on the work vehicle 10. However, it should be appreciated that the fluid tank 64 may be positioned at any other suitable location, such as the on the agricultural implement 10. Additionally, a pump 66 may be fluidly coupled to the fluid circuit 60 for pumping the fluid through the fluid circuit 60 in a flow direction (as indicated by arrow 34). The fluid circuit 60 may include fluid conduit 62, such as flexible tubes or hoses, for conveying the pressurized flow of fluid. However, it should be appreciated that the fluid circuit 60 may include any other suitable type of fluid conduit for conveying the pressurized flow of fluid.

Furthermore, the fluid circuit 60 includes a blocking valve 68 for blocking or shutting off the flow of pressurized fluid within the fluid circuit 60 between the fluid-driven actuator 100 and the fluid tank 64 or dispensing the flow of pressurized fluid from the fluid circuit 60. In this respect, the blocking valve 68 prevents the fluid-driven actuator 100 from adjusting the soil penetration depth 56 of the ground-engaging tools. As such, the blocking valve 68 may include a solenoid (not shown) or other actuatable component for limiting or preventing the flow of pressurized fluid. As will be described below, the blocking valve 68 may be coupled to a power source (not shown) and be electrically de-energized/activatable or energized/de-activatable by a relay or computing system to limit the flow of pressurized fluid within the fluid circuit 60. In some embodiments, the blocking valve 68 is positioned fluidly downstream of the fluid-driven actuator 100 between the fluid-driven actuator 100 and the fluid tank 64. In this respect, the blocking valve 68 is configured to limit or prevent the flow of pressurized fluid from the fluid-driven actuator 100, thus preventing the fluid-driven actuator 100 from raising the frame 40, 42, 44 and therefore decreasing the soil penetration depth 56 of the ground-engaging tools.

Additionally, a relay 112, such as an electrically operated switch, is configured to de-energize/activate the blocking valve 68 when the proximity sensor(s) 108 detects the presence of the linkage assembly(ies) 80 and energize/de-activate the blocking valve 68 when the proximity sensor(s) 108 does not detect the presence of the linkage assembly(ies) 80. The relay 112 may be electrically coupled to the proximity sensor 108 and the blocking valve 68. When the activation plate 86 enters the detection range of the proximity sensor 108, the proximity sensor 108 may send an electrical signal to the relay 112. The electrical signal, in turn, causes the relay 112 to de-energize/activate the blocking valve 68 by cutting off an electrical energy supply to the blocking valve 68, thus limiting or preventing the flow of pressurized fluid within the fluid circuit 60. Likewise, when the activation plate 86 is outside of the detection range of the proximity sensor 108, the proximity sensor 108 may send an electrical signal to the relay 112. The electrical signal, in turn, causes the relay 112 to energize/de-activate the blocking valve 68 by permitting the electrical energy supply to the blocking valve 68, thus permitting the flow of pressurized fluid within the fluid circuit 60. Limiting or preventing the flow of pressurized fluid when the activation plate 86 enters the detection range of the proximity sensor 108 prevents the fluid-driven actuator 100 from adjusting the soil penetration depth 56 of the ground-engaging tools when the translational arm 82 of the linkage assembly 80 is within a selected position range. Outside of the selected position range, the linkage assembly 80 may sustain damage.

Moreover, the system 200 includes a computing system 210 communicatively coupled to one or more components of the implement 10, the work vehicle 12, and/or the system 200 to allow the operation of such components to be electronically or automatically controlled by the computing system 210. For instance, the computing system 210 may be communicatively coupled to the fluid-driven actuator(s) 100 via a communicative link 202. As such, the computing system 210 may be configured to control an operation of the fluid-driven actuator(s) 100 to adjust the soil penetration depth 56 of the ground-engaging tools of the implement 10. Furthermore, the computing system 210 may be communicatively coupled to the proximity sensor(s) 108 via the communicative link 202. As such, the computing system 210 may be configured to detect the presence of the linkage assembly 80 when the linkage assembly 80 moves into the detection range of the proximity sensor(s) 108. Moreover, the computing system 210 may be communicatively coupled to the blocking valve 68 of the fluid circuit 60 via the communicative link 202. In this respect, the computing system 210 may be configured to control the operation of the blocking valve 68 to limit the flow of pressurized fluid within the fluid circuit 60. In addition, the computing system 210 may be communicatively coupled to any other suitable components of the implement 10, the vehicle 12, and/or the system 200.

In general, the computing system 210 may comprise any suitable processor-based device known in the art, such as a given controller or computing device or any suitable combination of controllers or computing devices. Thus, in several embodiments, the computing system 210 may include one or more processor(s) 212 and associated memory device(s) 214 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 214 of the computing system 210 may generally comprise memory element(s) including, but not limited to, a computer readable medium (e.g., random access memory (RAM)), a computer readable non-volatile medium (e.g., a flash memory), a floppy disc, a compact disc-read only memory (CD-ROM), a magneto-optical disc (MOD), a digital versatile disc (DVD), and/or other suitable memory elements. Such memory device(s) 214 may generally be configured to store suitable computer-readable instructions that, when implemented by the processor(s) 212, configure the computing system 210 to perform various computer-implemented functions, such as one or more aspects of the methods and algorithms that will be described herein. In addition, the computing system 210 may also include various other suitable components, such as a communications circuit or module, one or more input/output channels, a data/control bus and/or the like.

It should be appreciated that the computing system 210 may correspond to an existing computing system(s) of the implement 10, itself, or the computing system 210 may correspond to a separate processing device. For instance, in one embodiment, the computing system 210 may form all or part of a separate plug-in module that may be installed in association with the implement 10 to allow for the disclosed systems to be implemented without requiring additional software to be uploaded onto existing control devices of the implement 10. Additionally, or alternatively, in one embodiment, the computing system 210 may correspond to a controller or other computing system that is included within or otherwise part of a sensor and/or relay, such as the proximity sensor(s) 108 and the relay 112.

Furthermore, it should also be appreciated that the functions of the computing system 210 may be performed by a single processor-based device or may be distributed across any number of processor-based devices, in which instance such devices may be considered to form part of the computing system 210. For instance, the functions of the computing system 210 may be distributed across multiple application-specific controllers or computing devices, such as a navigation controller, an engine computing controller, a transmission controller, an implement controller and/or the like.

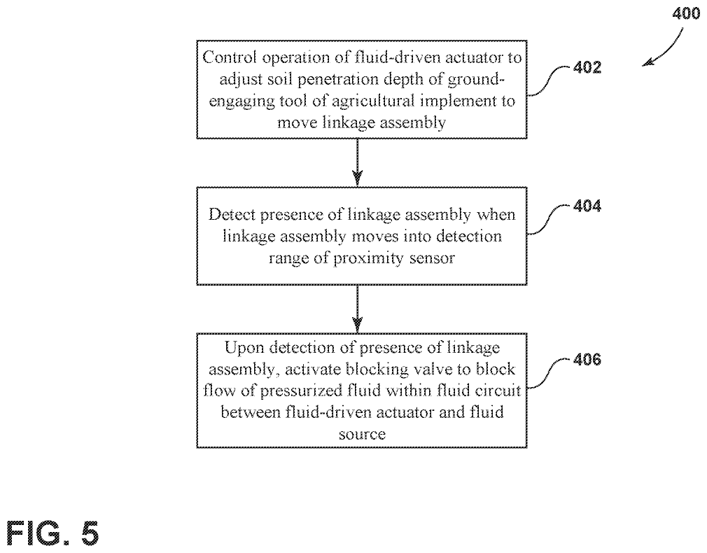

Referring now to FIG. 5, a flow diagram of one embodiment of a method 400 for controlling the operation of an agricultural implement is illustrated in accordance with aspects of the present subject matter. In general, the method 400 will be described herein with reference to the tillage implement 10 and the system 200 described above with reference to FIGS. 1-4. However, it should be appreciated by those of ordinary skill in the art that the disclosed method 400 may generally be implemented with any agricultural implements having any suitable implement configuration and/or within any system having any suitable system configuration. In addition, although FIG. 5 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 5, at (402), the method 400 includes controlling, with a computing system, an operation of a fluid-driven actuator to adjust a soil penetration depth of a ground-engaging tool of an agricultural implement to move a linkage assembly. For instance, as described above, the computing system 210 is communicatively coupled to the fluid-driven actuator(s) 100. As such, the computing system 210 may be configured to control the operation of the fluid-driven actuator(s) 100 to adjust the soil penetration depth of the harrow disks 50 and/or other ground-engaging tools to move the linkage assembly(ies) 80.

Additionally, at (404), the method 400 includes detecting, with the computing system, a presence of the linkage assembly when the linkage assembly moves into a detection range of a proximity sensor. For instance, as described above, the computing system 210 may be communicatively coupled to the proximity sensor(s) 108 via the communicative link 202. As such, the computing system 210 may configured to detect the presence of the linkage assembly(ies) 80 when the linkage assembly(ies) 80 moves into the detection range of the proximity sensor(s) 108.

Moreover, at (406), upon detection of the presence of the linkage assembly, the method 400 includes activating, with the computing system, a blocking valve to block a flow of pressurized fluid within a fluid conduit between the fluid-driven actuator and a fluid source. For instance, as described above, the computing system 210 may be communicatively coupled to the blocking valve 68 via the communicative link 202. As such, the computing system 210 may be configured to activate the blocking valve 68 to limit or prevent the flow of pressurized fluid within the fluid circuit 60 between the fluid driven actuator(s) 100 and the fluid tank 64.

It is to be understood that the steps of the method 400 are performed by the computing system 210 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the computing system 210 described herein, such as the method 400, is implemented in software code or instructions which are tangibly stored on a tangible computer readable medium. The computing system 210 loads the software code or instructions via a direct interface with the computer readable medium or via a wired and/or wireless network. Upon loading and executing such software code or instructions by the computing system 210, the computing system 210 may perform any of the functionality of the computing system 210 described herein, including any steps of the method 400 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. An agricultural implement, comprising:
a frame;
a ground-engaging tool supported by the frame for penetrating soil of a field as the agricultural implement traverses the field;
a fluid-driven actuator for adjusting a soil penetration depth of the ground-engaging tool;
a linkage assembly coupled to the frame and configured to move with the frame when the soil penetration depth of the ground-engaging tool is adjusted;
a fluid circuit for conveying a flow of pressurized fluid between the fluid-driven actuator and a fluid source, the fluid circuit comprising a blocking valve configured to be electrically energized and de-energized such that, when energized, the blocking valve permits the flow of pressurized fluid between the fluid-driven actuator and the fluid source to allow the fluid-driven actuator to adjust the soil penetration depth of the ground engaging tool and, when de-energized, the blocking valve blocks the flow of pressurized fluid between the fluid-driven actuator and the fluid source to prevent the fluid-driven actuator from adjusting the soil penetration depth of the ground-engaging tool;
a proximity sensor configured to detect a presence of the linkage assembly when the linkage assembly moves into a detection range of the proximity sensor; and
a relay configured to activate the blocking valve when the proximity sensor detects the presence of the linkage assembly.

2. The agricultural implement of claim 1, wherein:
the linkage assembly includes a plate protruding therefrom, the plate positioned on the linkage assembly such that a presence of the plate is detected by the proximity sensor when the plate moves into the detection range of the proximity sensor.

3. The agricultural implement of claim 2, wherein:
the proximity sensor is configured as a magnetic sensor configured to detect the presence of the plate when the plate moves into the detection range of the magnetic sensor.

4. The agricultural implement of claim 1, wherein the frame corresponds to a tool frame, the agricultural implement further comprising:
a main implement frame coupled to the tool frame, the tool frame movable relative to the main implement frame,
wherein the linkage assembly is coupled between the tool frame and the main implement frame and configured to move with the tool frame when the soil penetration depth of the ground-engaging tool is adjusted.

5. The agricultural implement of claim 1, wherein the fluid-driven actuator is configured as a hydraulically driven actuator and the fluid circuit is configured as a hydraulic circuit for conveying a flow of pressurized hydraulic fluid between the hydraulically driven actuator and a hydraulic fluid source.

6. The agricultural implement of claim 1, wherein the linkage assembly is configured to move toward the detection range of the proximity sensor with decreases in the soil penetration depth of the ground-engaging tool.

7. The agricultural implement of claim 1, wherein the linkage assembly is configured to move away from the detection range of the proximity sensor with increases in the soil penetration depth of the ground-engaging tool.

8. The agricultural implement of claim 1, wherein:
when the blocking valve of the fluid circuit is de-energized, the blocking valve is configured to limit the flow of pressurized fluid between the fluid-driven actuator and the fluid source to prevent the fluid-driven actuator from decreasing the soil penetration depth of the ground-engaging tool.

9. The agricultural implement of claim 1, wherein the agricultural implement is configured as a tillage implement.

10. The agricultural implement of claim 1, wherein the ground-engaging tool is configured as a harrow disk blade that rotates within the soil of the field as the agricultural implement traverses the field.

11. A system for controlling the operation of an agricultural implement, the system comprising:
a ground-engaging tool for penetrating soil of a field as an agricultural implement traverses the field;
a fluid-driven actuator for adjusting a soil penetration depth of the ground-engaging tool;
a linkage assembly coupled to a frame of the agricultural implement and configured to move when the soil penetration depth of the ground-engaging tool is adjusted;
a fluid circuit for conveying a flow of pressurized fluid between the fluid-driven actuator and a fluid source, the fluid circuit comprising a blocking valve that, when activated, blocks the flow of pressurized fluid between the fluid-driven actuator and the fluid source to prevent the fluid-driven actuator from adjusting the soil penetration depth of the ground-engaging tool;
a proximity sensor configured to detect a presence of the linkage assembly when the linkage assembly moves into a detection range of the proximity sensor; and
a relay configured to activate the blocking valve when the proximity sensor detects the presence of the linkage assembly.

12. The system of claim 11, wherein:
the linkage assembly includes a plate protruding therefrom, the plate positioned on the linkage assembly such that a presence of the plate is detected by the proximity sensor when the plate moves into the detection range of the proximity sensor.

13. The system of claim 12, wherein:
the proximity sensor is configured as a magnetic sensor configured to detect the presence of the plate when the plate moves into the detection range of the magnetic sensor.

14. The system of claim 11, wherein the fluid-driven actuator is configured as a hydraulically driven actuator and the fluid circuit is configured as a hydraulic circuit for conveying a flow of pressurized hydraulic fluid between the hydraulically driven actuator and a hydraulic fluid source.

15. The system of claim 11, wherein the linkage assembly is configured to move toward the detection range of the proximity sensor with decreases in the soil penetration depth of the ground-engaging tool.

16. The system of claim 11, wherein the linkage assembly is configured to move away from the detection range of the proximity sensor with increases in the soil penetration depth of the ground-engaging tool.

17. The system of claim 11, wherein:
when the blocking valve of the fluid circuit is activated, the blocking valve is configured to limit the flow of pressurized fluid between the fluid-driven actuator and the fluid source to prevent the fluid-driven actuator from decreasing the soil penetration depth of the ground-engaging tool.

18. A method of controlling the operation of an agricultural implement, the method comprising:
controlling, with a computing system, an operation of a fluid-driven actuator to adjust a soil penetration depth of a ground-engaging tool of an agricultural implement to move a linkage assembly;
detecting, with the computing system, a presence of the linkage assembly when the linkage assembly moves into a detection range of a proximity sensor; and
upon detection of the presence of the linkage assembly, activating, with the computing system, a blocking valve to block a flow of pressurized fluid within a fluid circuit between the fluid-driven actuator and a fluid source.
